(19) United States
(12) Patent Application Publication
(10) Pub. No.: US 2007/0213211 A1
(43) Pub. Date: Sep. 13, 2007

(54) Process for producing inorganic particles for selectively removing contaminants from fluids

(76) Inventor: Fernando Cesar Fernandes, Sao Paulo (BR)

Correspondence Address: STITES & HARBISON PLLC, 1199 NORTH FAIRFAX STREET, SUITE 900, ALEXANDRIA, VA, 22314, US

(21) Appl. No.: 11/502,638

(22) Filed: Aug. 11, 2006

(30) Foreign Application Priority Data
Mar. 7, 2006 (BR) PI 0600873-9

(51) Int. Cl. B01J 20/00

(52) U.S. Cl. 502/400; 502/407; 502/415

(57) ABSTRACT

The present paper proposes the production process of an inorganic medium, particulate, regeneratable, and able to remove contaminants by catalytic oxidation or reduction, as well as heavy metals removal by absorption from superficial, subterranean or dirty waters. The specific material is constituted by a composite of porous inorganic particles, on which surface it occurs the deposition of gamma dioxide manganese or epsilon manganese, the product showing a great selectivity and a high capacity, and may be produced into different granulometries, porosities and densities, and may also be produced specifically to meet different requirements of separators projects.

### BACKGROUND OF THE INVENTION

1. Field of the Invention

The present Invention refers to a process related to the chemistry and environmental engineering, applied to the production of inorganic particles.

2. Description of the Prior Art

The human beings are increasingly claiming the resources from the environment, altering this way its own habitat and the habitat of other organisms also living on Earth. These claims are increasing due to population growth, but mainly due to the improvement of the quality of life of the population.

One of the essential constituents of the human environment is water. Water represents the basic condition of the physiologic existence for men and other live organisms. Besides life maintenance, water has its prime use in agriculture and other purposes such as industry, transports, recreation and etc.

The distribution and the quality of water varies greatly, from plenty and of excellent quality as in the Amazon Region, to extremely limited and with bad quality as in sterile African regions, making it the most valuable mineral property we have. Its use, in most parts of the terrestrial globe, is accomplished in a rationing way and the tendency is to reach scarcity.

Rejected substances thrown in an ecosystem usually causes an alteration in water quality due to contaminations. The natural water cycle has been shown to be deficient to supply a good quality or water at required quantities. This is an indication that the recirculation routes and artificial depollution should be more intensively used.

Contaminants and its levels in waters and effluents vary widely. Contamination with iron, manganese, arsenic and dye substances such as humus, are important due to its disseminated occurrence in superficial and subterranean waters.

Several methods for removing manganese, iron and dye substances such as humus, from contaminated water, are known, including: oxidation by ozone or oxidizing agents, an absorption using active charcoal and contact filtering methods, use of natural or synthetic manganese dioxide as the manganese deposited in zeolite (Greensand), and coagulation and sedimentation methods using coagulants. Combinations of all of these methods are also possible.

Oxidation methods using ozone or an oxidant agent, as potassium permanganate for example, are disadvantageous due to high costs of the treatment. Ozone use requires a further treatment to prevent air pollution with the released ozone. The absorption method using active charcoal is not effective due to the low absorption of iron, manganese, arsenic and dye substances.

The contact filtering method uses filters on which the filtering media is constituted by manganese dioxide particles. A material commercially available uses zeolite impregnated with manganese dioxide. This kind of zeolite is prepared by immersing zeolite in a divalent manganese solution and stimulating the oxidant agent, such as potassium permanganate, to obtain manganese dioxide deposited on the surface of zeolite. In this method a great amount of an expensive chemical product is used resulting in a high cost treatment. If crude, natural water, with a high iron or manganese content is treated, these contaminants removal is not complete. As the manganese dioxide is deposited on the surface, it may fall from the surface and be lost in the reverse-rinsing, deteriorating the zeolite quality. Particles of electrolytic manganese dioxide are also used on the removal of iron and manganese. The disadvantage is its high cost, its high density and its nodules form.

In general, the manganese dioxide is accepted as having the property of removing iron, manganese, arsenic and water dye substances by itself. For a practical use in water purification equipments such as percolation filters, manganese dioxide should be presented in a proper physical appearance, that is, a granular form with an established granulometry, in order to produce a porous bed with an appropriate permeability. Not only the manganese dioxide particles should have an adequate granulometric distribution, but also have particles with a form factor and a density that causes a dynamic fluid behavior, to ease the filter reverse-rinsing and regeneration. The existing manganese dioxide products show these permanent characteristics, not allowing any modifications in projects for filters for water treatment.

The proposal presented herein solves these deficiencies, showing a new manganese dioxide product and the process for producing the product. The characteristics of this new manganese dioxide product is its high reactivity which is shown in the efficiency of the removal of water contaminants, its high treatment capacity, requiring a less frequent reverse-rinsing and reactivation, the possibility to be produced in wide categories of granulometric distribution, and showing various densities, in accordance with the deposition substrate and in accordance with the requisites and requirements for filters projects.

The process of the present invention is applied to the production of inorganic particles composed by a porous inorganic support and a gamma superficial manganese dioxide, (CMD). These particles may constitute a porous media with different granulometries, able to remove contaminants for catalytic oxidation or reduction, as well as to absorb heavy metals. The choice of porous support of different densities enables the production of composite particles of different densities, satisfying the density and size requirements for the construction and manufacturing of filters for the treatment of fluids, in particular for water, of a large number of different characteristics. Some odors, tastes and contaminants, such as hydrogen sulfide, iron, manganese, arsenic, radium, chrome and lead, may be oxidized and retained by the filtering media, and further removed from the system by water or water in combination with common chemical products in a reverse-rinsing operation. The medium regeneration may be effectuated with an oxidant, such as chlorine, sodium hypochlorite or potassium permanganate, among others. This product demonstrates a high selectivity grade and a high capacity of removing contaminants, mainly iron and manganese.

### SUMMARY OF THE INVENTION

The present invention provides a particulate material produced with a feature to remove undesirable contaminants from water. Specifically this particulate material, which constitutes a filtering media, has application on the removal of sulfides, iron, manganese, arsenic, radium and other contaminants, including but not limited to, heavy metals from water for consumption and waters from superficial and subterranean origin. Particulate material for this use is a composite of inorganic material particles, from natural or artificial origin, such as silica, clays, calcinated clays, alumina, pumice and others, with several porosity and specific surface levels. A gamma manganese dioxide layer is deposited over these support materials.

Manganese dioxide deposition over support material is effectuated immersing the particles in a manganese nitrate solution of high purity, removing the particles from solution, and draining the excess of liquids, drying and decomposing the remaining manganese nitrate through a thermic treatment, obtaining NO₂ and the development of a gamma manganese dioxide on the surface. This procedure may be repeated several times to increase the thickness of the deposited layer. The deposited layer in this way, remains firmly thigh adhered to the support. The material is subsequently rinsed to neutralize the remaining acid present in it up to a pH=7, and then dried. Through correctly and properly choosing the supporting surface, it is possible to produce a composite with varied density and with a high specific surface.

This process chemically produces composed gamma manganese dioxide particles (CMD), which is applied to the removal of hydrogen sulfide, iron, manganese, radium, lead, metals from arsenic family, several other heavy metals, chlorine, dissolved solids and etc. The filtering media, constituted by the particles of the composite material, has a very high capacity of elimination of this contaminants and it is easily regenerated without damaging the media.

The present invention seeks to provide a process for producing inorganic particles for selectively remove contaminants from fluids, comprising a particulate, regeneratable, oxidizing, reducing, catalytic and absorbent filtering medium for removing contaminants from superficial, subterraneous, dirty and potable water, the process comprising depositing a film of manganese dioxide through a chemical process over a porous inorganic support particulate.

### DETAILED DESCRIPTION OF THE INVENTION

Manganese dioxide is an oxide of a great stability and very inert, even when it is exposed to severe chemical media, which may be observed from its behavior in nature. Geologically, deep beds of very pure manganese dioxide were formed from protominerals several years ago. Hardpan components, such as silica, iron, aluminum, calcium, magnesium etc., were slowly lixiviated making manganese dioxide more stable, as a residual product.

In addition to its inherent stability, which makes it not susceptible to lixiviation in drinkable water, the manganese dioxide deposits show affinity for certain metals such as cobalt, nickel, silver, copper and etc., which are contaminants commonly found in manganese ores. This natural charge of natural manganese dioxide makes them less effective in water treatment than artificial manganese dioxides, such as chemically or electrolytically prepared dioxides.

A high purity and gamma manganese dioxide of low cost became available from several ores, through the chemical synthesis of manganese dioxide from the manganese nitrate solution. There are several methods for the production of chemical manganese dioxide, called CMD; particularly the method used in this process is originated from a manganese nitrate solution. This solution may be obtained by the lixiviation of manganese monoxide with nitric acid, or by the lixiviation of manganese dioxide with a solution containing NOₓ. Regardless of the method for obtaining it, the manganese nitrate solution should be purified. One of the manners to purify the manganese solution is to concentrate by evaporation until the precipitation of a first fraction of manganese dioxide. This first precipitated fraction drags impurities, and it is separated by filtration. The concentrated filtration product is purified and may be dissolved, if necessary, to effectuate the impregnation of support particles.

The support particles, after rinsed and dried, are covered by a manganese nitrate solution and then subsequently dried between 110° C. and 200° C. The particles are then calcinated in water and oxygen vapor atmosphere, at 110° C. to 400° C. during a period of time enough to decompose the nitrate into NOₓ and precipitate over the surface of the gamma manganese dioxide support. The precipitated dioxide remains firmly adhered to the support and is subsequently rinsed up to the obtainment of a pH around seven. The catalytic absorbent of manganese dioxide may be considered ready for use. The great reactivity of catalytic absorbent produced through this process is due to the quality of the manganese dioxide precipitated over the support particles. The manganese dioxide exists under several ore forms known as alpha, beta, gamma, delta epsilon and ramsdellite.

The fundamental unity of manganese dioxide is a structure on which a Mn⁴⁺ ion is bound to six oxygen ions, making an octagon and where the units are bound by the common edges. The units are combined to form single or multiple channels, layers and rings or structures, according to the structure represented bellow:

The gamma structure, occurring in the nsutite mineral, has an intergrowing of ramsdellite phase with pyrolusite, which is characterized by a substantial disorder on its structure together with a significant non-stoichiometry. This disorder creates a great number of discordance on the structure, which allows for atoms excursions through it, and allowing a complete use of the oxide layer, and not only its external surface, granting a great activity. The epsilon phase occurs as a thermic decomposition of manganese nitrate at 150° C. or less, and it is the main constituent of electrolytic manganese dioxide. This phase is similar to the gamma phase, with structural disorder and high reactivity.

The filtering medium, constituted by particles composed by an inorganic granular support and a deposit of gamma and epsilon phases manganese dioxide on its surface, have been used to selectively remove a great number of water contaminants. After a long period of use, manganese and iron oxides are gradually deposited on the filtering bed, and these deposited materials are periodically eliminated by a reverse-rinsing. Simultaneously with the physical cleaning, the bed may be completely regenerated with the use of common reagents. The regeneration operation occurs by passing some volumes of aqueous chlorine solutions through the bed. Sodium hypochlorite and hydrochloric acid. The regeneration completely restitutes the bed properties.

The particulate filtering medium is a regeneratable, oxidizing/reducer, catalytic and absorbent, for the removal of water contaminants of superficial origin, such as rivers, lakes etc., or subterraneous, such as wells, or even potable water or dirty waters; contaminants including heavy metals, lead, metals of arsenic family, chlorine, dissolved solids and many others, mainly iron and manganese. The particles composing this filtering medium is a composite constituted by porous inorganic particles, from natural or artificial origin, such as clays, rocks, ceramics, aluminas, zirconia, silica, or any other type of inorganic particles, over which a film of manganese dioxide is deposited through chemical processes.

It should be understood that the preferred embodiments mentioned here are merely illustrative of the present invention. Numerous variations in design and use of the present invention may be contemplated in view of the following claims without straying from the intended scope and field of the invention herein disclosed.

Having thus described the invention, what is claimed as new and secured by Letters Patent is:

1. A process for producing inorganic particles for selectively removing contaminants selected from the group consisting of: heavy metals, lead, metals of arsenic family, chlorine, dissolved solids, iron, manganese and combination thereof; from fluids selected from the group consisting of: superficial water, subterraneous water, dirty water and potable water; comprising a particulate, regeneratable, oxidizing, reducing, catalytic and absorbent filtering medium, the process comprising depositing a film of manganese dioxide through a chemical process over a porous inorganic support particles selected from the group consisting of: clays, rocks, ceramics, aluminas, zirconia, silica and combinations thereof.

2. The process according to claim 1, wherein the film of manganese dioxide is from a manganese nitrate solution.

3. The process according to claim 1, wherein the step of depositing a film of manganese dioxide through a chemical process over a porous inorganic support particulate comprises the steps of;
(a) placing the support particles inside an oven having an internal water vapor/oxygen rate within a range between 10/1 and 1/10
(b) covering the support particles with the manganese nitrate solution;
(c) drying the covered support particles at a temperature range of between 110° C. and 200° C.;
(d) thermically treating the covered support particles for decomposing the nitrate at a temperature range of between 100° C. and 400° C., obtaining NOₓ and precipitating MnO₂ repeating the deposition procedure to a maximum of ten times, if necessary.

4. The process according to claim 3, wherein the water vapor/oxygen rate inside the oven is 4/1.

5. The process according to claim 1, wherein the mineralogical structure of the manganese dioxide is selected from the group consisting of: gamma and epsilon.

6. The process according to claim 1, wherein the support particles are particles of variable granulometry.

7. The process according to claim 1, wherein the support particles are particles of variable densities.

8. The process according to claim 1, wherein the covered filtering particles are regenerated by a rinsing process with a solution selected from the group consisting of: chlorine in aqueous solution, permanganates, sodium hypochlorite and sulfuric acid.
